(19) United States
(12) Patent Application Publication
(10) Pub. No.: US 2022/0355771 A1
(43) Pub. Date: Nov. 10, 2022

(54) ELECTRIC BRAKE APPARATUS, BRAKE CONTROL APPARATUS, AND CONTROL PARAMETER CALIBRATION METHOD

(71) Applicant: Hitachi Astemo, Ltd., Hitachinaka-shi, Ibaraki (JP)

(72) Inventor: Haruhiko FUJITA, Hitachinaka-shi, Ibaraki (JP)

(21) Appl. No.: 17/619,763

(22) PCT Filed: Jun. 22, 2020
(86) PCT No.: PCT/JP2020/024318

§ 371 Date: Dec. 16, 2021

(30) Foreign Application Priority Data
Jun. 26, 2019 (JP) 2019-118453

(51) Int. Cl. B60T 8/17; B60T 13/74

(52) U.S. Cl. CPC B60T 8/17; B60T 13/74

(57) ABSTRACT

A main ECU controls a braking force by driving an electric motor of a brake mechanism based on a value detected by a thrust force sensor provided to the brake mechanism. The main ECU calibrates (corrects) the value detected by the thrust force sensor based on a driving force acquired when, while a driving force is applied to left and right front wheels serving as driving wheels with the braking force applied to a rear right wheel or a rear left wheel by the brake mechanism, this driving force exceeds the braking force.

### TECHNICAL FIELD

The present invention relates to an electric brake apparatus that applies a braking force to a vehicle such as an automobile, a brake control apparatus, and a control parameter calibration method.

### BACKGROUND ART

For example, PTLs 1 and 2 each discuss an electric brake apparatus mounted on a vehicle such as an automobile.

### CITATION LIST

### Patent Literature

PTL 1: Japanese Patent Application Public Disclosure No. 2003-106355
PTL 2: Japanese Patent Application Public Disclosure No. 2012-159134

### SUMMARY OF INVENTION

### Technical Problem

If a difference occurs between braking forces (brake forces) generated by brake mechanisms (electric brake mechanisms) mounted on the left side and the right side of the vehicle, respectively, a driver may feel uncomfortable.

### Solution to Problem

An object of the present invention is to provide an electric brake apparatus, a brake control apparatus, and a control parameter calibration method that can eliminate or reduce a difference between braking forces of brake mechanisms mounted on the left side and the right side of a vehicle, respectively.

According to one aspect of the present invention, an electric brake apparatus includes a brake mechanism. The brake mechanism is provided for each of left and right wheels. The brake mechanism is configured to transmit a thrust force generated by driving an electric motor to a piston based on a braking request. The piston is configured to move a braking member to be pressed against a braking receiving member. The electric brake apparatus further includes a brake control apparatus configured to control a braking force by driving the electric motor based on at least one control parameter. The brake control apparatus calibrates the control parameter for driving the electric motor of the brake mechanism mounted on the wheel based on a driving force acquired when the driving force on a driving wheel exceeds the braking force while the driving force is applied to the driving wheel with the braking force applied to the wheel.

Further, according to one aspect of the present invention, a brake control apparatus includes a control portion configured to control a braking force by driving an electric motor of a brake mechanism based on at least one control parameter. The brake mechanism is provided for each of left and right wheels, and is configured to transmit a thrust force generated by driving the electric motor to a piston based on a braking request. The piston is configured to move a braking member to be pressed against a braking receiving member. The control portion calibrates the control parameter for driving the electric motor of the brake mechanism mounted on the wheel based on a driving force acquired when the driving force on a driving wheel exceeds the braking force while the driving force is applied to the driving wheel with the braking force applied to the wheel.

Further, according to one aspect of the present invention, a control parameter calibration method includes calibrating a control parameter for driving an electric motor of a brake mechanism mounted on a wheel based on a driving force acquired when the driving force on a driving wheel exceeds a braking force while the driving force is applied to the driving wheel with the braking force applied to the wheel by the brake mechanism, The brake mechanism is configured to transmit a thrust force generated by driving the electric motor to a piston. The piston is configured to move a braking member to be pressed against a braking receiving member.

According to the one aspect of the present invention, the difference can be eliminated or reduced between the braking forces of the brake mechanisms mounted on the left side and the right side of the vehicle, respectively.

### BRIEF DESCRIPTION OF DRAWINGS

FIG. 1 schematically illustrates the system configuration of a vehicle on which an electric brake apparatus and a brake control apparatus according to an embodiment are mounted.

FIG. 2 schematically illustrates a brake mechanism illustrated in FIG. 1 together with a main ECU.

FIG. 3 is a flowchart illustrating processing for calibrating a control parameter performed by the main ECU illustrated in FIG. 1.

FIG. 4 illustrates an outline of the processing for calibrating the control parameter.

FIG. 5 illustrates a line representing a characteristic indicating one example of the relationship between a braking torque, and a thrust force sensor value, a rotational angle sensor value, or a current sensor value.

### DESCRIPTION OF EMBODIMENTS

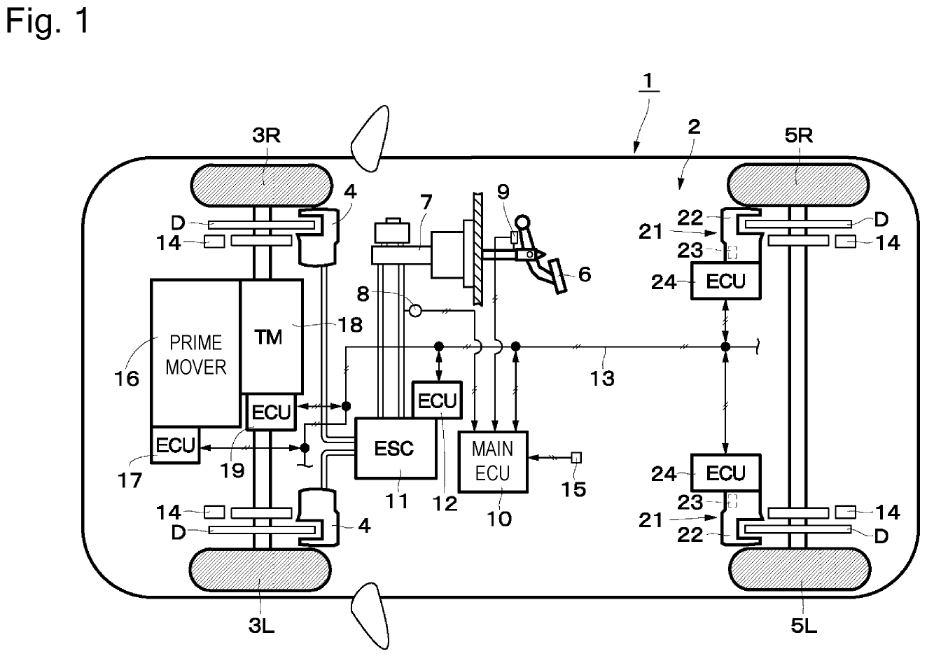

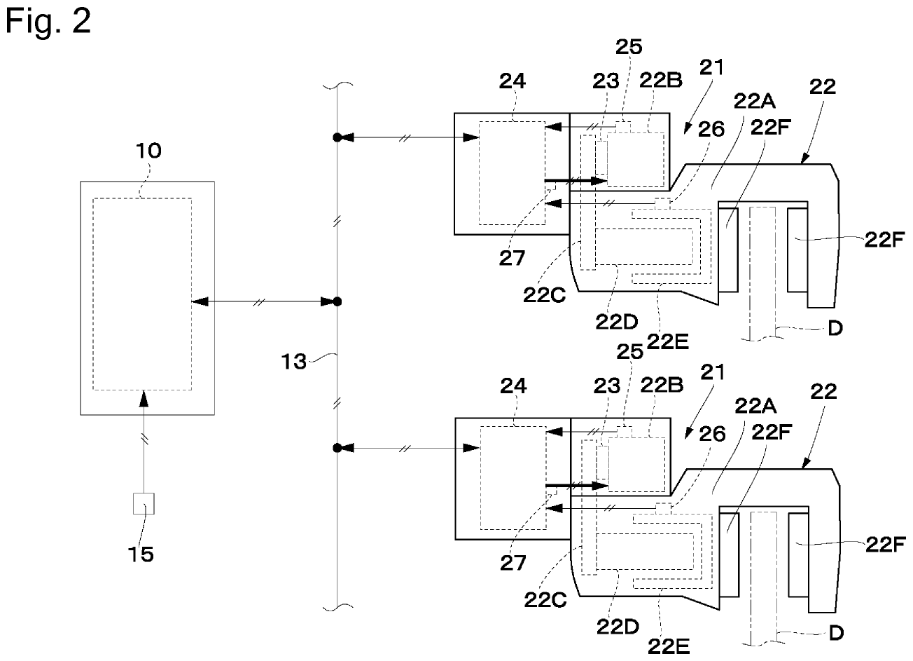

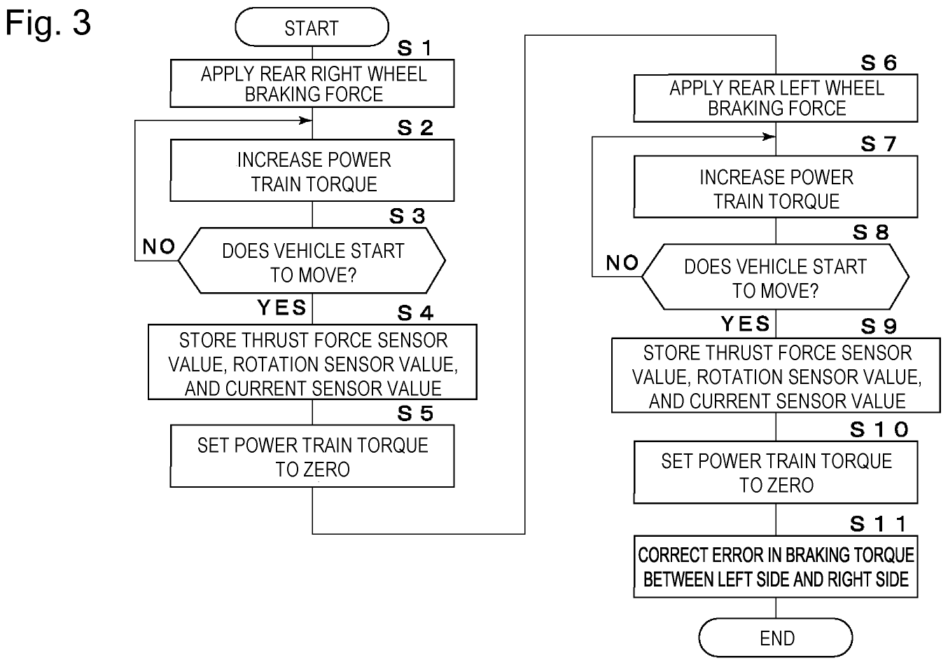

In the following description, an electric brake apparatus and a brake control apparatus according to an embodiment will be described based on an example in which they are mounted on a four-wheeled automobile with reference to the accompanying drawings. Each of steps in a flowchart illustrated in FIG. 3 will be represented by the symbol “S” (for example, assume that step 1 is represented by “S1). Further, lines with two slash marks added thereto in FIGS. 1 and 2 indicate electricity-related lines.

In FIG. 1, a vehicle 1 is equipped with a brake apparatus 2 (a vehicle brake apparatus or a brake system), which applies braking forces to wheels (front wheels 3L and 3R and rear wheels 5L and 5R) to brake the vehicle 1. The brake apparatus 2 includes left and right hydraulic brake apparatuses 4 and 4 (a front braking mechanism), left and right electric brake apparatuses 21 and 21 (a rear braking mechanism), a master cylinder 7, and a hydraulic pressure sensor 8 and a pedal stroke sensor 9. The left and right hydraulic brake apparatuses 4 and 4 are provided in correspondence with the left-side front wheel 3L and the right-side front wheel 3R. The left and right electric brake apparatuses 21 and 21 are provided in correspondence with the left-side rear wheel 5L and the right-side rear wheel 5R. The master cylinder 7 generates a hydraulic pressure according to an operation (pressing) of a brake pedal 6 (an operation member). The hydraulic pressure sensor 8 and the pedal stroke sensor 9 measure the amount of the operation performed on the brake pedal 6 by an operator (a driver).

The hydraulic brake apparatus 4 is formed by, for example, a hydraulic disk brake, and applies the braking force to the wheel (the front wheel 3L or 3R) according to the supply of a hydraulic pressure (a brake hydraulic pressure) thereto. The electric brake apparatus 21 is formed by, for example, an electric disk brake, and applies the braking force to the wheel (the rear wheel 5L or 5R) according to driving of an electric motor 22B (refer to FIG. 2). The hydraulic pressure sensor 8 and the pedal stroke sensor 9 are connected to a main ECU 10.

A hydraulic pressure supply apparatus 11 (hereinafter referred to as an ESC 11) is provided between the master cylinder 7 and the hydraulic brake apparatuses 4 and 4. The ESC 11 includes, for example, a plurality of control valves, a hydraulic pressure pump, an electric motor, and a hydraulic pressure control reservoir (any of them is not illustrated). The hydraulic pressure pump pressurizes the brake hydraulic pressure. The electric motor drives this hydraulic pressure pump. The hydraulic pressure control reservoir temporarily stores extra brake fluid. Each of the control valves and the electric motor in the ESC 11 are connected to a front hydraulic pressure apparatus ECU 12. The front hydraulic pressure apparatus ECU 12 includes a microcomputer. The front hydraulic pressure apparatus ECU 12 controls the opening/closing of each of the control valves and the driving of the electric motor in the ESC 11 based on an instruction from the main ECU 10.

The main ECU 10 includes a microcomputer. The main ECU 10 calculates a target barking force for each of the wheels (the four wheels) according to a predetermined control program in reaction to inputs of signals from the hydraulic pressure sensor 8 and the pedal stroke sensor 9. The main ECU 10 transmits a braking instruction directed to each of the front two wheels to the front hydraulic pressure apparatus ECU 12 (i.e., an ESC ECU) via a CAN 13 (Control Area Network) serving as a vehicle data bus based on the calculated braking force (the target braking force that should be applied to each of the front two wheels). The main ECU 10 transmits a braking instruction (a target thrust force) directed to each of the rear two wheels to each of rear electric brake ECUs 24 and 24 via the CAN 13 based on the calculated braking force (the target braking force that should be applied to each of the rear two wheels).

Wheel speed sensors 14 and 14 are provided near the front wheels 3L and 3R and the rear wheels 5L and 5R, respectively. The wheel speed sensors 14 and 14 detect the speeds of these wheels 3L, 3R, 5L, and 5R (a wheel speed). The wheel speed sensors 14 and 14 are connected to the main ECU 10. The main ECU 10 can acquire the wheel speed of each of the wheels 3L, 3R, 5L, and 5R based on a signal from each of the wheel speed sensors 14 and 14. Further, the main ECU 10 receives vehicle information transmitted from another ECU mounted on the vehicle 1 (for example, a prime mover control ECU 17 and a transmission control ECU 19, which will be described below) via the CAN 13. More specifically, the main ECU 10 acquires various kinds of vehicle information such as information about the position of the AT range selector or the position of the MT shifter, information about ON/OFF of the ignition, information about the engine speed, information about the power train torque, information about the transmission gear ratio, information about an operation on the steering wheel, information about a clutch operation, information about an accelerator operation, information about communication between vehicles, information about the surroundings of the vehicle acquired by the in-vehicle camera, and information about the acceleration senor (the longitudinal acceleration and the lateral acceleration) via the CAN 13.

Further, a parking brake switch 15 is provided near the driver's seat. The parking brake switch 15 is connected to the main ECU 10. The parking brake switch 15 transmits a signal (an actuation request signal) corresponding to a request to actuate the parking brake (an application request serving as a holding request or a release request serving as a releasing request) according to an operation instruction from the driver to the main ECU 10. The main ECU 10 transmits a parking brake instruction directed to each of the rear two wheels to each of the rear electric brake ECUs 24 and 24 based on the operation on the parking brake switch 15 (the actuation request signal). The parking brake switch 15 corresponds to a switch that actuates a parking mechanism 23.

The electric brake apparatus 21 includes a brake mechanism 22, a parking mechanism 23 as the braking force holding mechanism, the main ECU 10 and the rear electric brake ECU 24 as the brake control apparatus. In this case, the electric brake apparatus 21 controls the position and the thrust force of the brake mechanism 22. To achieve this control, the brake mechanism 22 includes a rotational angle sensor 25, a thrust force sensor 26, and a current sensor 27 (refer to FIG. 2 for all of them). The rotational angle sensor 25 serves as a position detector that detects a motor rotational position. The thrust force sensor 26 serves as a thrust force detector that detects a thrust force (a piston thrust force). The current sensor 27 serves as a current detector that detects a motor current.

The brake mechanism 22 is provided for each of the left and right wheels of the vehicle 1, i.e., the rear left wheel 5L side and the rear right wheel 5R side. The brake mechanism 22 is configured as an electric brake mechanism including the electric motor 22B. As illustrated in, for example, FIG. 2, the brake mechanism 22 includes a caliper 22A as a cylinder (a wheel cylinder), the electric motor 22B as an electric motor (an electric actuator), a speed reduction mechanism 22C, a rotation-linear motion conversion mechanism 22D, a piston 22E as a pressing member, brake pads 22F as a braking member (a pad), and a not-illustrated fail-open mechanism (a return spring). The electric motor 22B is driven (rotated) according to the supply of electric power thereto, and thrusts forward the piston 22E. By this operation, the electric motor 22B provides the braking force. The electric motor 22B is controlled by the rear electric brake ECU 24 based on the braking instruction (the target thrust force) from the main ECU 10. The speed reduction mechanism 22C slows down the rotation of the electric motor 22B and transmits it to the rotation-linear motion conversion mechanism 22D.

The rotation-linear motion conversion mechanism 22D converts the rotation of the electric motor 22B transmitted via the speed reduction mechanism 22C into an axial displacement of the piston 22E (a linear-motion displacement). The piston 22E is thrust forward according to the driving of the electric motor 22B, and moves the brake pads 22F. The brake pads 22F are pressed against a disk rotor D as a braking receiving member (a disk) by the piston 22E. The disk rotor D rotates together with the wheel (the rear wheel 5L or 5R). When the braking is applied, the not-illustrated return spring (the fail-open mechanism) applies a rotational force to a rotational member of the rotation-linear motion conversion mechanism 22D in a braking release direction. In the brake mechanism 22, the piston 22E is thrust forward so as to press the brake pads 22F against the disk rotor D based on the driving of the electric motor 22B. In other words, the brake mechanism 22 transmits the thrust force generated according to the driving of the electric motor 22B to the piston 22E moving the brake pads 22F based on the braking request (the braking instruction).

The parking mechanism 23 is provided to each of the brake mechanisms 22 and 22, i.e., each of the brake mechanism 22 on the left side (the rear left wheel 5L side) and the brake mechanism 22 on the right side (the rear right wheel 5R side). The parking mechanism 23 keeps the piston 22E of the brake mechanism 22 in the forward thrust state. In other words, the parking mechanism 23 holds and releases the braking force. The parking mechanism 23 maintains the braking force by engaging a part of the brake mechanism 22. The parking mechanism 23 is formed by, for example, a ratchet mechanism (a lock mechanism), which prohibits (locks) the rotation by engaging (hooking) an engagement claw (a lever member) with a ratchet (a ratchet gear). In this case, the engagement claw is engaged with the ratchet by, for example, driving a solenoid controlled by the main ECU 10 and the rear electric brake ECU 24. As a result, the rotation of a rotational shaft of the electric motor 22B is prohibited and the braking force is maintained.

The rear electric brake ECU 24 is provided in correspondence with each of the brake mechanisms 22 and 22, i.e., each of the brake mechanism 22 on the left side (the rear left wheel 5L side) and the brake mechanism 22 on the right side (the rear right wheel 5R side). The rear electric brake ECU 24 includes a microcomputer. The rear electric brake ECU 24 controls the brake mechanism 22 (the electric motor 22B) and the parking mechanism 23 (the solenoid) based on the instruction from the main ECU 10. In other words, the rear electric brake ECU 24 forms a control apparatus (the brake control apparatus) that controls the actuation of the electric motor 22B (and the parking mechanism 23) together with the main ECU 10. In this case, the rear electric brake ECU 24 controls the driving of the electric motor 22B based on the braking instruction (the target thrust force). Along therewith, the rear electric brake ECU 24 controls the driving of the parking mechanism 23 (the solenoid) based on the actuation instruction. The braking instruction and the actuation instruction are input from the main ECU 10 to the rear electric brake ECU 24.

The rotational angle sensor 25 detects the rotational angle of the rotational shaft of the electric motor 22B (the motor rotational angle). The rotational angle sensor 25 is provided in correspondence with each of the respective electric motors 22B of the brake mechanisms 22, and forms the position detector that detects the rotational position of the electric motor 22B (the motor rotational position) and thus the piston position. The thrust force sensor 26 detects a reaction force to the thrust force (the pressing force) applied from the piston 22E to the brake pads 22F. The thrust force sensor 26 is provided to each of the brake mechanisms 22, and forms the thrust force detector that detects the thrust force applied to the piston 22E (the piston thrust force). The current sensor 27 detects a current supplied to the electric motor 22B (the motor current). The current sensor 27 is provided in correspondence with each of the respective electric motors 22B of the brake mechanisms 22, and forms the current detector that detects the motor current (a motor torque current) of the electric motor 22B. The rotational angle sensor 25, the thrust force sensor 26, and the current sensor 27 are connected to the rear electric brake ECU 24.

The rear electric brake ECU 24 (and the main ECU 10 connected to this rear electric brake ECU 24 via the CAN 13) can acquire the rotational angle of the electric motor 22B based on the signal from the rotational angle sensor 25. The rear electric brake ECU 24 (and the main ECU 10) can acquire the thrust force applied to the piston 22E based on the signal from the thrust force sensor 26. The rear electric brake ECU 24 (and the main ECU 10) can acquire the motor current supplied to the electric motor 22B based on the signal from the current sensor 27.

Next, the operation of applying the braking and releasing the braking by the electric brake apparatus 21 will be described. In the following description, this operation will be described citing an operation performed when the driver operates the brake pedal 6 as an example. However, the electric brake apparatus 21 also operates approximately similarly even in the case of autonomous brake, except that the operation in this case is different in terms of, for example, the fact that an instruction for the autonomous brake is output from an autonomous brake ECU (not illustrated) or the main ECU 10 to the rear electric brake ECU 24.

For example, when the driver operates the brake pedal 6 by pressing it while the vehicle 1 is running, the main ECU 10 outputs the instruction according to the pressing operation on the brake pedal 6 (for example, the target thrust force corresponding to the instruction to apply the braking) to the rear electric brake ECU 24 based on the detection signal input from the pedal stroke sensor 9. The rear electric brake ECU 24 drives (rotates) the electric motor 22B in a forward direction, i.e., in a braking applying direction (an application direction) based on the instruction from the main ECU 10. The rotation of the electric motor 22B is transmitted to the rotation-linear motion conversion mechanism 22D via the speed reduction mechanism 22C, and the piston 22E is moved forward toward the brake pads 22F.

As a result, the brake pads 22F and 22F are pressed against the disk rotor D, and the braking force is applied. The braking state is established by controlling the driving of the electric motor 22B based on the detection signals from the pedal stroke sensor 9, the rotational angle sensor 25, the thrust force sensor 26, and the like at this time. While such control is ongoing, a force in a braking release direction is applied to the rotational member of the rotation-linear motion conversion mechanism 22D and thus the rotational shaft of the electric motor 22B by the not-illustrated return spring provided to the brake mechanism 22.

On the other hand, when the brake pedal 6 is operated toward a pressing release side, the main ECU 10 outputs the instruction according to this operation (for example, the target thrust force corresponding to the braking release instruction) to the rear electric brake ECU 24. The rear electric brake ECU 24 drives (rotates) the electric motor 22B in a reverse direction, i.e., a braking releasing direction (a release direction) based on the instruction from the main ECU 10. The rotation of the electric motor 22B is transmitted to the rotation-linear motion conversion mechanism 22D via the speed reduction mechanism 22C, and the piston 22E is moved backward in a direction away from the brake pad 22F. Then, when the pressing of the brake pedal 6 is completely released, the brake pads 22F and 22F are separated from the disk rotor D, and the braking force is released. In a non-braking state in which the braking is released in this manner, the not-illustrated return spring provided to the brake mechanism 22 is returned to the initial state thereof.

Next, thrust force control and position control by the electric brake apparatus 21 will be described.

The main ECU 10 determines the braking force that should be generated by the electric brake apparatus 21, i.e., the target thrust force that should be generated on the piston 22E based on detection data, the autonomous brake instruction, and the like from various kinds of sensors (for example, the pedal stroke sensor 9). The main ECU 10 outputs the target thrust force serving as the braking instruction to the rear electric brake ECU 24. The rear electric brake ECU 24 controls the thrust force based on the piston thrust force detected by the thrust force sensor 26 as a feedback and controls the position based on the motor rotational position detected by the rotational angle sensor 25 as a feedback on the electric motor 22B so as to generate the target thrust force on the piston 22E.

In other words, in the brake mechanism 22, the thrust force of the piston 22E is adjusted based on the braking force instruction (the target thrust force) from the main ECU 10 and a feedback signal from the thrust force sensor 26, which measures the thrust force of the piston 22E. To determine the thrust force, torque control of the electric motor 22B via the rotation-linear motion conversion mechanism 22D and the speed reduction mechanism 22C is performed, i.e., current control is performed based on a feedback signal of the current sensor 27, which measures the current amount supplied to the electric motor 22B. Therefore, the braking force, and the piston thrust force, the torque of the electric motor 22B (the motor torque), the current value, and the piston position (a value resulting from measuring the number of rotations of the electric motor 22B by the rotational angle sensor 25) are in a correlated relationship. However, the control based on the thrust force sensor 26, which estimates the piston pressing force strongly correlated with the braking force, is desirable because the braking force varies depending on the environment and a variation in the parts.

The thrust force sensor 26 deforms a metallic strained body by receiving the force of the piston 22E in the thrust direction, and detects the strain amount thereof. The strain sensor is a strain IC, and includes a piezoresistance that detects a strain at the center of the top surface of a silicon chip, and a Wheatstone bridge, an amplification circuit, and a semiconductor process disposed around it. The strain sensor detects the strain applied to the strain sensor as a resistance change by utilizing the piezoresistance effect. The strain sensor may be formed by a strain gauge or the like.

Further, as illustrated in FIG. 1, the vehicle 1 includes a prime mover 16 serving as a power source for acquiring a force thrusting the vehicle 1, and a reducer transmission 18 for efficiently transmitting the torque and the speed (the rotational speed) of the prime mover 16. The prime mover 16 can be formed by, for example, an engine and an electric motor or an electric motor alone in addition to being able to be formed by an engine (an internal combustion engine) alone. The prime mover 16 outputs a driving force (a rotation) for causing the vehicle 1 to run. The prime mover 16 includes the prime mover control ECU 17 for controlling the prime mover 16. The reducer transmission 18 is a gearbox also called a transmission, and outputs the rotation of the prime mover 16 after slowing down it in a multistep or stepless manner. The rotation output from the prime mover 16 via the reducer transmission 18 is transmitted to a driving wheel, such as the front wheels 3L and 3R. As a result, the front wheels 3L and 3R rotate, and the vehicle 1 runs. The reducer transmission 18 includes the transmission control ECU 19 for controlling the reducer transmission 18. The prime mover control ECU 17 and the transmission control ECU 19 are connected to the front hydraulic pressure apparatus ECU 12, the main ECU 10, and the rear electric brake ECU 24 via the CAN 13. Control information of the prime mover 16 and control information of the reducer transmission 18 are shared with the front hydraulic pressure apparatus ECU 12, the main ECU 10, and the rear electric brake ECU 24 via the CAN 13.

Then, if a difference occurs between the braking forces (the brake forces) generated by the brake mechanisms (the electric brake mechanisms) mounted on the left side and the right side of the vehicle, respectively, the driver may feel uncomfortable. More specifically, if a difference occurs between the braking force on the rear left wheel 5L and the braking force on the rear right wheel 5R (a difference in the braking force between the left side and the right side), a yaw may occur on the vehicle and necessitate a steering correction. Due to that, the driver may feel that the rigidity of the vehicle is low and his/her sense of safety may reduce. Now, the feedback control using the monitoring thrust force sensor for determining the braking force (the brake force) is performed as the control of the electric motor of the brake mechanism, and the difference in the brake force between the left side and the right side is caused by the accuracy of the thrust force sensor, a variation in the frictional coefficient of the pad, and the like.

Then, conventional hydraulic mechanical brakes can reduce the variation because the difference in the brake force between the left side and the right side is determined based on the machining tolerance of the piston or the like. On the other hand, the brake mechanism may lead to a significant variation depending on the accuracy of the thrust force sensor. The thrust force sensor amplifies a strain gauge that mainly detects a strain by constructing a bridge, converts analog data into digital data by an A/D converter, and transmits and receives data via communication. Further, to convert the load on the brake piston into the strain, it is necessary to, for example, process highly hard metal with high precision and ensure the accuracy of the temperature characteristic of the amplification circuit, and it is necessary to increase the accuracy as a whole. Therefore, it is desired to allow the difference in the braking force to be eliminated or reduced even when the accuracy of the thrust force sensor is reduced and even when accurate processing is not satisfied.

Under these circumstances, in the embodiment, the difference in the braking force is eliminated or reduced by calibrating (adjusting) the thrust force sensor 26 by a method that will be described below (a control parameter calibration method) even when a simple thrust force sensor (a less accurate thrust force sensor) is used. Further, in the embodiment, the difference in the braking force is eliminated or reduced by performing control while assuming (estimating) the thrust force by replacing it with a substitute value using the value of the rotational angle sensor 25 (the motor rotational angle or the piston position) or the value of the current sensor (the current) in the correlated relationship with the value of the thrust force sensor 26 (the thrust force). In other words, in the embodiment, the braking torque is corrected based on the driving torque of the power train. More specifically, the sensor value (the thrust force sensor 26, the rotational angle sensor 25, and the current sensor 27) is calibrated based on a relationship of the driving torque of the power train=the braking torque. As the driving torque, for example, an engine driving torque is used for conventional vehicles, and a motor driving torque is used for BEVs (Battery Electric Vehicles). Then, a control parameter for driving the electric motor of the brake mechanism is calibrated based on the driving force acquired when the driving force exceeds the braking force while the driving force (the driving torque) is applied with the braking force applied to one of the wheels of the vehicle (for example, the rear right wheel 5R or the rear left wheel 5L). In this case, the control parameter is calibrated for each one of the left and right wheels.

This will be described more specifically. In the embodiment, the main ECU 10 and the rear electric brake ECU 24 (hereinafter also referred to as simply the main ECU 10) control the driving of the electric motor 22B of the brake mechanism 22. The main ECU 10 controls the braking force by driving the electric motor 22B of the brake mechanism 22 based on at least one control parameter, such as at least any of the thrust force, the position (the piston position), and the current. In other words, the main ECU 10 includes a control portion that controls the braking force by driving the electric motor 22B of the brake mechanism 22 based on at least one control parameter (a state amount for use in the feedback control). In this case, the main ECU 10 (a control portion thereof) calibrates (corrects) the control parameter for driving the electric motor 22B of the brake mechanism 22 mounted on the wheel (the rear right wheel 5R or the rear left wheel 5L) based on the driving force acquired when the driving force on the wheel (the driving wheel) exceeds the braking force while the driving force is applied to the driving wheel (for example, the left and right front wheels 3L and 3R) with the braking force applied to the wheel (for example, the rear right wheel 5R or the rear left wheel 5L) by the brake mechanism 22. For example, at least any of the value detected by the thrust force sensor 26, the instructed current value for driving the electric motor 22B, and the piston position converted from the value detected by the rotational angle sensor 25 for driving the electric motor 22B can be used as the control parameter to calibrate.

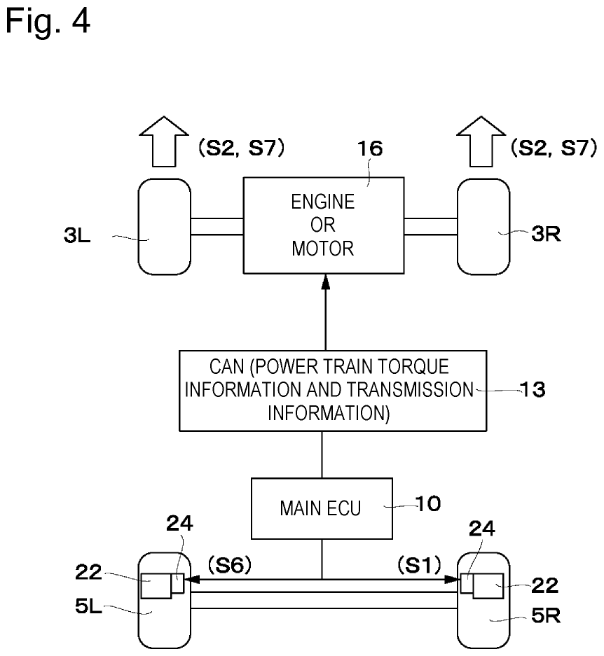

In other words, in the embodiment, as illustrated in FIG. 4, the main ECU 10 (the control portion thereof) calibrates the control parameter on one wheel side (the rear right wheel 5R) based on the driving force acquired when the driving force on the driving wheel (the left and right front wheels 3L and 3R) exceeds the braking force on the one wheel (the rear right wheel 5R) while the driving force is applied to the driving wheel (for example, the left and right front wheels 3L and 3R) with the braking force applied to the one wheel (for example, the rear right wheel 5R). After that, the main ECU 10 (the control portion thereof) calibrates the control parameter on the other wheel side (the rear left wheel 5L) based on the driving force acquired when the driving force on the driving wheel (the left and right front wheels 3L and 3R) exceeds the braking force on the other wheel (the rear left wheel 5L) while the driving force is applied to the driving wheel (for example, the left and right front wheels 3L and 3R) with the braking force applied to the other wheel (for example, the rear left wheel 5L). In sum, the main ECU 10 (the control portion thereof) calibrates the control parameter of the brake mechanism 22 on the other wheel (the rear left wheel 5L) after calibrating the control parameter of the brake mechanism 22 on the one wheel (the rear right wheel 5R).

More specifically, the calibration of the control parameter according to the embodiment includes the following steps (processing) (1) to (4). The one wheel is assumed to be the rear right wheel 5R and the other wheel is also assumed to be the rear left wheel 5L in the description, but the one wheel may be the rear left wheel 5L and the other wheel may also be the rear right wheel 5R.
(1) The main ECU 10 applies the driving force to the left and right front wheels 3L and 3R by the prime mover 16 with the braking force applied to the rear right wheel 5R by the brake mechanism 22 on the rear right wheel 5R side. More specifically, the main ECU 10 applies a predetermined braking torque only to the rear right wheel 5R by the brake mechanism 22 of the rear right wheel 5R with the vehicle 1 stopped (a vehicle stop state). In this case, the main ECU 10 applies the predetermined braking force by, for example, supplying electric power to the electric motor 22B of the brake mechanism 22 of the rear right wheel 5R according to a preset predetermined current value (instructed current value). Alternatively, the main ECU 10 applies the braking force in such a manner that the value detected by the thrust force sensor 26 of the brake mechanism 22 of the rear right wheel 5R matches a predetermined braking torque. Then, in this state, i.e., with the predetermined braking force applied by the brake mechanism 22 of the rear right wheel 5R, the main ECU 10 applies the torque of the prime mover 16 (the power train torque: the engine torque or the motor torque).
(2) The main ECU 10 calibrates the control parameter of the brake mechanism 22 on the rear right wheel 5R side based on the driving force acquired when the driving force on the left and right front wheels 3L and 3R exceeds the braking force on the rear right wheel 5R. More specifically, the main ECU 10 calculates the driving torque based on the torque of the prime mover 16 acquired at the moment that (at the instant that) the vehicle 1 starts to move while the torque of the prime mover 16 is gradually increased, and the gear ratio of the reducer transmission 18 (the transmission gear ratio). The calculated driving torque=the rear right wheel braking torque is established at the moment that the vehicle 1 starts to move, and the value of the thrust force sensor 26 (the thrust force sensor value), the value of the rotational angle sensor 25 (the rotation sensor value), and the value of the current sensor 27 (the current sensor value) at this time are stored into the memory of the main ECU 10. Then, the main ECU 10 calibrates (corrects) the thrust force sensor value, the rotation sensor value, and the current sensor value into a thrust force sensor value, a rotation sensor value, and a current sensor value (an instructed current value) corresponding to the rear right wheel braking torque equivalent to the driving torque acquired at the moment that the vehicle 1 starts to move.
(3) The main ECU 10 applies the driving force to the left and right front wheels 3L and 3R by the prime mover 16 with the braking force applied to the rear left wheel 5L by the brake mechanism 22 on the rear left wheel 5L side. More specifically, the main ECU 10 applies a predetermined braking torque only to the rear left wheel 5L by the brake mechanism 22 of the rear left wheel 5L with the vehicle 1 stopped (the vehicle stop state). In this case, the main ECU 10 applies the predetermined braking force by, for example, supplying electric power to the electric motor 22B of the brake mechanism 22 of the rear left wheel 5L according to a preset predetermined current value (instructed current value). Alternatively, the main ECU 10 applies the braking force in such a manner that the value detected by the thrust force sensor 26 of the brake mechanism 22 of the rear left wheel 5L matches a predetermined braking torque. Then, in this state, i.e., with the predetermined braking force applied by the brake mechanism 22 of the rear left wheel 5L, the main ECU 10 applies the torque of the prime mover 16 (the power train torque: the engine torque or the motor torque).
(4) The main ECU 10 calibrates the control parameter of the brake mechanism 22 on the rear left wheel 5L side based on the driving force acquired when the driving force on the left and right front wheels 3L and 3R exceeds the braking force on the rear left wheel 5L. More specifically, the main ECU 10 calculates the driving torque based on the torque of the prime mover 16 acquired at the moment that (at the instant that) the vehicle 1 starts to move while the torque of the prime mover 16 is gradually increased, and the gear ratio of the reducer transmission 18 (the transmission gear ratio). The calculated driving torque=the rear left wheel braking torque is established at the moment that the vehicle 1 starts to move, and the value of the thrust force sensor 26 (the thrust force sensor value), the value of the rotational angle sensor 25 (the rotation sensor value), and the value of the current sensor 27 (the current sensor value) at this time are stored into the memory of the main ECU 10. Then, the main ECU 10 calibrates (corrects) the thrust force sensor value, the rotation sensor value, and the current sensor value into a thrust force sensor value, a rotation sensor value, and a current sensor value (an instructed current value) corresponding to the rear left wheel braking torque equivalent to the driving torque acquired at the moment that the vehicle 1 starts to move.

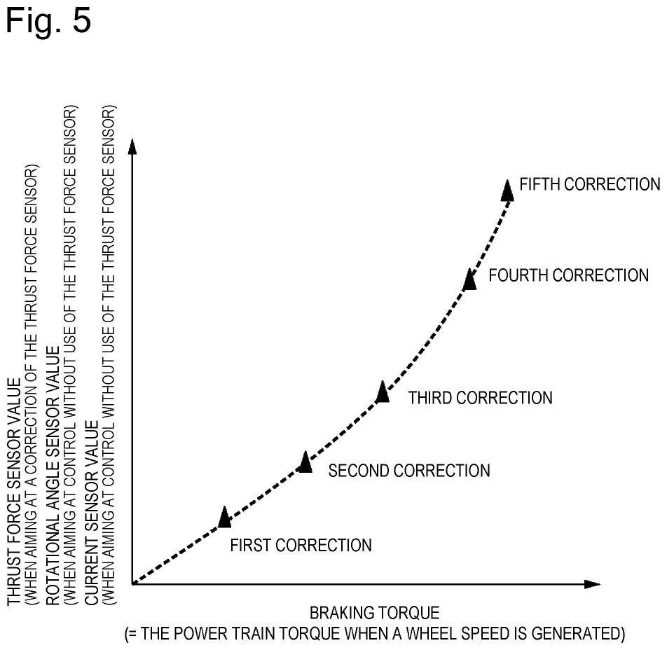

By the steps (processing) (1) to (4) performed in this manner, the main ECU 10 calibrates (corrects) the control parameter of the brake mechanism 22 on the rear right wheel 5R side and the control parameter of the brake mechanism 22 on the rear left wheel 5L side based on the driving torque of the power train that serves as a common reference. As a result, an error in the braking torque between the left side and the right side can be corrected. Then, the main ECU 10 repeats the steps (processing) (1) to (4) while changing the predetermined braking force (braking torque) to be applied by the brake mechanism 22. For example, the main ECU 10 conducts the first calibration (correction) to the fifth calibration (correction) while changing the braking torque as illustrated in FIG. 5. As a result, the main ECU 10 can calibrate (correct) the relationship between the braking torque, and the thrust force sensor value, the rotational sensor value, and the current sensor value over the entire range of the braking torque.

FIG. 3 illustrates the processing for calibrating the control parameter that is performed by an arithmetic circuit of the main ECU 10. A processing program for performing this processing flow illustrated in FIG. 3 is, for example, stored in the memory of the main ECU 10. When the control processing illustrated in FIG. 3 is started, in S1, the main ECU 10 applies the rear right wheel braking force. More specifically, the main ECU 10 applies the predetermined braking force to the rear right wheel 5R by the brake mechanism 22 on the rear right wheel 5R side. For example, the main ECU 10 supplies electric power to the electric motor 22B of the brake mechanism 22 of the rear right wheel 5R according to the present predetermined current value. In S2, the main ECU 10 increases the power train torque. In other words, the main ECU 10 increases the output of the prime mover 16. In S3, the main ECU 10 determines whether the vehicle 1 starts to move. The main ECU 10 detects whether the vehicle 1 starts to move by, for example, the wheel speed sensors 14 and 14. If the main ECU 10 determines “NO”, i.e., determines that the vehicle 1 does not start to move in S3, the processing returns to S2, in which the main ECU 10 increases the power train torque to a torque higher than ever before. If the main ECU 10 determines “YES”, i.e., determines that the vehicle 1 starts to move in S3, the processing proceeds to S4. In S4, the main ECU 10 stores the driving force (the driving torque), the thrust force sensor value, the rotation sensor value, and the current sensor value acquired at the moment that the vehicle 1 starts to move into the memory. In S5, the main ECU 10 sets the power train torque to zero.

In the subsequent step, S6, the main ECU 10 applies the rear left wheel braking force. More specifically, the main ECU 10 applies the predetermined braking force to the rear left wheel 5L by the brake mechanism 22 on the rear left wheel 5L side. For example, the main ECU 10 supplies electric power to the electric motor 22B of the brake mechanism 22 of the rear left wheel 5L according to the present predetermined current value. In S7, the main ECU 10 increases the power train torque. In other words, the main ECU 10 increases the output of the prime mover 16. In S8, the main ECU 10 determines whether the vehicle 1 starts to move. The main ECU 10 detects whether the vehicle 1 starts to move by, for example, the wheel speed sensors 14 and 14. If the main ECU 10 determines “NO”, i.e., determines that the vehicle 1 does not start to move in S8, the processing returns to S7, in which the main ECU 10 increases the power train torque to a torque higher than ever before. If the main ECU 10 determines “YES”, i.e., determines that the vehicle 1 starts to move in S8, the processing proceeds to S9.

In S9, the main ECU 10 stores the driving force (the driving torque), the thrust force sensor value, the rotation sensor value, and the current sensor value acquired at the moment that the vehicle 1 starts to move into the memory. In S10, the main ECU 10 sets the power train torque to zero. In S11, the main ECU 10 corrects the error in the braking torque between the left side and the right side. More specifically, the main ECU 10 calibrates (corrects) the thrust force sensor value, the rotation sensor value, and the current sensor value stored in the memory into the thrust force sensor value, the rotation sensor value, and the current sensor value corresponding to the braking torque equivalent to the driving torque acquired at the moment that the vehicle 1 starts to move for each of the rear right wheel 5R and the rear left wheel 5L. After calibrating the relationship between the thrust force sensor value, the rotation sensor value, and the current sensor value, and the braking torque in S11, the main ECU 10 ends the processing. The calibration (correction) can be conducted over the entire range of the braking torque as illustrated in FIG. 5 by repeating the processing from S1 to S11 while changing the value of the braking torque. Further, the main ECU 10 conducts the calibration for both the rear right wheel 5R side and the rear left wheel 5L side in S11 in FIG. 3, but may conduct the calibration for the rear right wheel 5R side after S4 or S5 and conduct the calibration for the rear left wheel 5L side after S9 or S10.

The control processing illustrated in FIG. 3 is started, for example, when the main ECU 10 determines that the calibration processing should be performed. For example, the calibration processing is started when the initial settings are configured at the time of the shipment of the vehicle 1 from the factory. In this case, the calibration (for example, the first correction to the fifth correction illustrated in FIG. 5) can be conducted over the entire range of the braking torque by repeating the calibration processing while changing the braking torque. Alternatively, the calibration processing can also be performed every time the vehicle 1 starts to run. For example, the main ECU 10 may be configured to perform the processing from S1 to S4 when the vehicle 1 starts to run and perform the processing from S6 to S11 when the vehicle 1 starts to run next after the vehicle 1 is stopped. In this case, preferably, the processing is performed with a braking torque not making the people riding on the vehicle 1 (the driver and the passenger(s)) feel uncomfortable. More specifically, one calibration correction (for example, the first correction in FIG. 5) can be conducted under a condition using a low braking torque when the vehicle 1 starts to run normally. Alternatively, for example, the calibration processing can also be performed at the time of autonomous valet parking, more specifically, when the vehicle 1 is dispatched to a user with autonomous driving. In this case, the calibration can be conducted over the entire range of the braking torque (for example, the first to fifth corrections in FIG. 5) by repeating the calibration processing for each braking torque. Further, the calibration is canceled, for example, when a rotation is detected only on a wheel provided with the braking force, lest the correction be made based on an incorrect value. Further, the calibration is also canceled when the yaw sensor detects a yaw.

Now, the driving torque can be expressed by the following equation 1.

driving torque=power train torque×transmission gear ratio×differential gear ratio [Equation 1]

The braking torque can be expressed by the following equation 2.

braking torque=piston thrust force×pad frictional coefficient×brake disk effective radius [Equation 2]

The piston thrust force can be expressed by the following equation 3. According to the equation 3, a proportional relationship is established between the motor current and the thrust force.

piston thrust force=motor current×motor torque×reducer gear ratio×(2 ×PI/lead length of rotation-linear motion conversion mechanism)×efficiency η [Equation 3]

Further, the motor rotation sensor can detect the piston position by counting the number of motor rotations according to the following equation 4. Then, the piston position and the thrust force are proportional to each other, provided that the cylinder rigidity is kept constant.

piston position=number of motor rotations×reducer reduction ratio×lead length of rotation-linear motion conversion mechanism [Equation 4]

Therefore, the piston position (the motor rotation sensor) or the motor current value (the current sensor) can be used as a substitute characteristic for the thrust value, and a variation in the components (a variation in the component accuracy, a variation in the temperature, and a variation due to aging deterioration) can be calibrated.

In the embodiment, the braking force can be controlled assuming that the thrust force sensor is a true value, by calibrating the value detected by the thrust force sensor. More specifically, in the embodiment, the “thrust force feedback control” can be performed by feeding back the value detected by the calibrated thrust force sensor on the instruction value for the thrust force. On the other hand, for example, “braking force feedback control” may also be performed as an instruction for the braking force by directly storing the braking force into the memory. The braking force can be substituted as the thrust force sensor value, the current sensor value, and the piston position value according to the equation 1 to the equation 4. In other words, the braking force feedback control can be realized by performing the thrust force feedback control, the current feedback control, and the piston position feedback control.

The embodiment has been described citing the example in which the power train torque (the driving torque) is generated with the braking torque generated, and the calibration is conducted based on the fact that the power train torque and the braking torque acquired at the moment that the wheel speed is generated match each other. However, the calibration method is not limited thereto, and may be performed by generating the braking torque with the power train torque remaining when the vehicle is being stopped, and conducting the calibration based on the fact that the power train torque and the braking torque acquired at the moment that the wheel speed is stopped match each other.

The embodiment has been described citing the example in which the electric brakes are employed for the left and right rear wheels among the four wheels. However, the layout of the electric brakes is not limited thereto, and, for example, the electric brakes may be employed for the left and right front wheels among the four wheels. Alternatively, for example, the electric brakes may be employed for all of the four wheels. In the case where the electric brakes are employed for all of the four wheels, the calibration can be achieved by, for example, calibrating the control parameter of the brake mechanism on one wheel side of the left and right front wheels and then calibrating the control parameter of the brake mechanism on the other wheel side of the left and right front wheels after that, and, subsequently, calibrating the control parameter of the brake mechanism on one wheel side of the left and right rear wheels and then calibrating the control parameter of the brake mechanism on the other wheel side of the left and right rear wheels after that.

In this manner, according to the embodiment, the control parameter is calibrated (corrected) based on the driving force acquired when the driving force on the front wheels 3L and 3R serving as the driving wheels exceeds the braking force with the braking force applied by driving the electric motor 22B of the brake mechanism 22 based on the control parameter (the thrust force sensor value, the current sensor value, and the piston position value). Therefore, the control parameter can be calibrated based on the driving force serving as one reference value (the power train torque). Then, the difference is eliminated or reduced between the left side and the right side in the braking force of the brake mechanism 22 mounted for each of the left and right rear wheels 5L and 5R by driving the electric motor 22B of the brake mechanism 22 based on this calibrated control parameter.

According to the embodiment, the control parameter is calibrated on the rear left wheel 3L side corresponding to the other wheel side after the control parameter is calibrated on the right rear wheel 3R side corresponding to the one wheel side. Therefore, the control parameter can be calibrated for each one of the left and right wheels. According to the embodiment, the value detected by the thrust force sensor 26, which is the control parameter, is calibrated. Therefore, the electric motor 22B of the brake mechanism 22 can be driven based on the calibrated detected value even without use of the highly accurate thrust force sensor 26, whereby the difference can be eliminated or reduced in the braking force between the left side and the right side.

According to the embodiment, the instructed current value, which is the control parameter, is calibrated. In this case, the braking force can be controlled with use of the instructed current value as a substitute for the value detected by the thrust force sensor 26. In other words, the difference in the braking force can be eliminated or reduced by driving the electric motor 22B of the brake mechanism 22 based on the calibrated instructed current value even without use of the thrust force sensor 26. Furthermore, in addition to being able to reduce the sensor cost, the omission of the thrust force sensor 26 can reduce, for example, the number of expensive shield harnesses having the high bend performance that connect the sensor and the ECU (the control apparatus), thereby being also able to reduce the cost from this viewpoint. Further, according to the embodiment, the piston position (the control parameter) converted from the value detected by the rotational angle sensor 25 for driving the electric motor 22B is calibrated. In this case, the cost can also be reduced in a similar manner.

The embodiment has been described citing the “value detected by the thrust force sensor 26”, the “instructed current value for driving the electric motor 22B (the value detected by the current sensor 27 corresponding thereto)”, and the “piston position converted from the value detected by the rotational angle sensor 25 for driving the electric motor 22B” as examples of the control parameter. In this case, the control of the electric motor of the brake mechanism and the calibration of the control parameter may be performed with use of all (three) of the control parameters or may be performed with use of any one of the control parameters. Alternatively, the control of the electric motor of the brake mechanism and the calibration of the control parameter may be performed with use of two control parameters among the three control parameters or may be performed with use of a control parameter different from them. In other words, the electric motor is driven and the braking force is controlled based on at least one control parameter.

The embodiment has been described citing the example configured in such a manner that the “main ECU 10”, the “rear electric brake ECU 24 on the rear left wheel 5L side”, and the “rear electric brake ECU 24 on the rear right wheel 5R side” are prepared as individually different ECUs from one another, and these three ECUs are connected via the CAN 13, which is the vehicle data bus. More specifically, the embodiment has been described citing the example in which the three ECUs, the main ECU 10 and the left and right rear electric brake ECUs 24 and 24 are configured as the control apparatuses for the electric brake apparatuses 21 and 21 (the electric brake control apparatuses). However, the arrangement of the ECUs is not limited thereto, and, for example, the main ECU and the rear electric brake ECU may be formed by one ECU. In other words, the control apparatus that controls the left and right electric motors may be formed by one ECU.

The embodiment has been described citing the example in which the rear electric brake ECU 24 is attached to the brake mechanism 22, by which these brake mechanism 22 and rear electric brake ECU 24 are configured as one unit (assembly). However, the brake mechanism and the rear electric brake ECU are not limited thereto, and, for example, may be disposed while being separated from each other. In this case, individually different electric brake ECUs (rear electric brake ECUs) may be provided for the left side (the rear left wheel side) and the right side (the rear right wheel side), respectively, or the rear electric brake ECU may be configured as one (a common) electric brake ECU (rear electric brake ECU) shared by the left side (the rear left wheel side) and the right side (the rear right wheel side).

The embodiment has been described citing the example in which the electric brake apparatus 21 is configured to calibrate the control parameter by the main ECU 10. However, the electric brake apparatus 21 is not limited thereto, and, for example, may be configured to calibrate the control parameter by the rear electric brake ECU 24 in addition to controlling the driving of the electric motor 22B by the rear electric brake ECU 24.

The embodiment has been described based on the example in which the hydraulic brake apparatuses 4 and 4 are employed on the front wheel 3L and 3R side and the electric brake apparatuses 21 and 21 are employed on the rear wheel 5L and 5R side. However, the layout of the brake apparatuses is not limited thereto, and, for example, the electric brake apparatuses and the hydraulic brake apparatuses may be employed on the front wheel side and the rear wheel side, respectively. Alternatively, for example, the electric brake apparatuses may be employed for all of the four wheels. Further, the driving wheels are set to the front wheels 3L and 3R in the embodiment, but may be set to the rear wheels 5L and 5R. Alternatively, the driving wheels may be set to the four wheels.

Possible configurations as the electric brake apparatus, the brake control apparatus, and the control parameter calibration method based on the above-described embodiment include the following examples.

As a first configuration, an electric brake apparatus includes a brake mechanism. The brake mechanism is provided for each of left and right wheels. The brake mechanism is configured to transmit a thrust force generated by driving an electric motor to a piston based on a braking request. The piston is configured to move a braking member to be pressed against a braking receiving member. The electric brake apparatus further includes a brake control apparatus configured to control a braking force by driving the electric motor based on at least one control parameter. The brake control apparatus calibrates the control parameter for driving the electric motor of the brake mechanism mounted on the wheel based on a driving force acquired when the driving force on a driving wheel exceeds the braking force while the driving force is applied to the driving wheel with the braking force applied to the wheel.

According to this first configuration, the control parameter is calibrated based on the driving force acquired when the driving force on the wheel exceeds the braking force with the braking force applied by driving the electric motor of the brake mechanism based on the control parameter. Therefore, the control parameter can be calibrated (corrected) based on the driving force (a power train torque) serving as one reference value. Then, the difference in the braking force of the brake mechanism mounted for each of the left and right wheels can be eliminated or reduced by driving the electric motor of the brake mechanism based on this calibrated control parameter.

As a second configuration, in the first configuration, for any one wheel of the left and the right wheels, the brake control apparatus calibrates the control parameter on the one wheel side based on the driving force acquired when the driving force on the driving wheel exceeds the braking force on the one wheel while the driving force is applied to the driving wheel with the braking force applied to the one wheel. After that, for the other wheel of the left and the right wheels, the brake control apparatus calibrates the control parameter on the other wheel side based on the driving force acquired when the driving force on the driving wheel exceeds the braking force on the other wheel while the driving force is applied to the driving wheel with the braking force applied to the other wheel. According to this second configuration, the control parameter is calibrated on the other wheel side after the control parameter is calibrated on the one wheel side. Therefore, the control parameter can be calibrated for each one of the left and right wheels.

As a third configuration, in the first configuration or the second configuration, the brake mechanism further includes a thrust force detection portion configured to detect the thrust force. The control parameter is a value detected by the thrust force detection portion. According to this third configuration, the control parameter that is the value detected by the thrust force detection portion can be calibrated (corrected). Therefore, the difference in the braking force can be eliminated or reduced by driving the electric motor of the brake mechanism based on the calibrated detected value even without use of a highly accurate thrust force detection portion.

As a fourth embodiment, in the first configuration or the second configuration, the control parameter is an instructed current value for driving the electric motor. According to this fourth configuration, the control parameter that is the instructed current value can be calibrated (corrected). In this case, the braking force can be controlled with use of the instructed current value as a substitute for the value detected by the thrust force detector. In other words, the difference in the braking force can be eliminated or reduced by driving the electric motor of the brake mechanism based on the calibrated instructed current value even without use of the thrust force detector. Furthermore, in addition to being able to reduce the sensor cost, the omission of the thrust force detector can reduce the number of expensive shield harnesses having the high bend performance that connect the sensor and the control apparatus, thereby being also able to reduce the cost from this viewpoint.

As a fifth configuration, a brake control apparatus includes a control portion configured to control a braking force by driving an electric motor of a brake mechanism based on at least one control parameter. The brake mechanism is provided for each of left and right wheels, and is configured to transmit a thrust force generated by driving the electric motor to a piston based on a braking request. The piston is configured to move a braking member to be pressed against a braking receiving member. The control portion calibrates the control parameter for driving the electric motor of the brake mechanism mounted on the wheel based on a driving force acquired when the driving force on a driving wheel exceeds the braking force while the driving force is applied to the driving wheel with the braking force applied to the wheel.

According to this fifth configuration, the control parameter is calibrated based on the driving force acquired when the driving force on the wheel exceeds the braking force with the braking force applied by driving the electric motor of the brake mechanism based on the control parameter. Therefore, the control parameter can be calibrated (corrected) based on the driving force (the power train torque) serving as one reference value, and the difference in the braking force of the brake mechanism mounted for each of the left and right wheels can be eliminated or reduced.

As a sixth configuration, a control parameter calibration method includes calibrating a control parameter for driving an electric motor of a brake mechanism mounted on a wheel based on a driving force acquired when the driving force on a driving wheel exceeds a braking force while the driving force is applied to the driving wheel with the braking force applied to the wheel by the brake mechanism, The brake mechanism is configured to transmit a thrust force generated by driving the electric motor to a piston. The piston is configured to move a braking member to be pressed against a braking receiving member. According to this sixth configuration, the control parameter of the electric motor is calibrated based on the driving force acquired when the driving force on the wheel exceeds the braking force with the braking force applied by driving the electric motor of the brake mechanism. Therefore, the control parameter can be calibrated (corrected) based on the driving force (the power train torque) serving as one reference value, and the difference in the braking force of the brake mechanism mounted for each of the left and right wheels can be eliminated or reduced.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each of embodiments can also be implemented with another configuration added, deleted, or replaced with respect to a part of the configuration of this embodiment.

The present application claims priority under the Paris Convention to Japanese Patent Application No. 2019-118453 filed on Jun. 26, 2019. The entire disclosure of Japanese Patent Application No. 2019-118453 filed on Jun. 26, 2019 including the specification, the claims, the drawings, and the abstract is incorporated herein by reference in its entirety.

### REFERENCE SIGNS LIST

3L, 3R front wheel (driving wheel)

5L, 5R rear wheel (wheel)

10 main ECU (brake control apparatus, control portion)

21 electric brake apparatus

22 brake mechanism

22B electric motor

22E piston

22F brake pad (braking member)

24 rear electric brake ECU (brake control apparatus, control portion)

26 thrust force sensor (thrust force detection portion)

D disk rotor (braking receiving member)

1-6. (canceled)

7. An electric brake apparatus comprising:
a brake mechanism, the brake mechanism being provided for each of left and right wheels, the brake mechanism being configured to transmit a thrust force generated by driving an electric motor to a piston based on a braking request, the piston being configured to move a braking member to be pressed against a braking receiving member; and
a brake control apparatus configured to control a braking force by driving the electric motor based on at least one control parameter,
wherein the brake control apparatus calibrates the control parameter for driving the electric motor of the brake mechanism mounted on the wheel based on a driving force acquired when the driving force on a driving wheel exceeds the braking force while the driving force is applied to the driving wheel with the braking force applied to the wheel.

8. The electric brake apparatus according to claim 7, wherein the brake control apparatus
for any one wheel of the left and the right wheels, calibrates the control parameter on the one wheel side based on the driving force acquired when the driving force on the driving wheel exceeds the braking force on the one wheel while the driving force is applied to the driving wheel with the braking force applied to the one wheel, and, after that,
for the other wheel of the left and the right wheels, calibrates the control parameter on the other wheel side based on the driving force acquired when the driving force on the driving wheel exceeds the braking force on the other wheel while the driving force is applied to the driving wheel with the braking force applied to the other wheel.

9. The electric brake apparatus according to claim 7, wherein the brake mechanism further includes a thrust force detection portion configured to detect the thrust force, and
wherein the control parameter is a value detected by the thrust force detection portion.

10. The electric brake apparatus according to claim 8, wherein the brake mechanism further includes a thrust force detection portion configured to detect the thrust force, and
wherein the control parameter is a value detected by the thrust force detection portion.

11. The electric brake apparatus according to claim 7, wherein the control parameter is an instructed current value for driving the electric motor.

12. The electric brake apparatus according to claim 8, wherein the control parameter is an instructed current value for driving the electric motor.

13. A brake control apparatus comprising:
a control portion configured to control a braking force by driving an electric motor of a brake mechanism based on at least one control parameter, the brake mechanism being provided for each of left and right wheels and configured to transmit a thrust force generated by driving the electric motor to a piston based on a braking request, the piston being configured to move a braking member to be pressed against a braking receiving member,
wherein the control portion calibrates the control parameter for driving the electric motor of the brake mechanism mounted on the wheel based on a driving force acquired when the driving force on a driving wheel exceeds the braking force while the driving force is applied to the driving wheel with the braking force applied to the wheel.

14. A control parameter calibration method comprising:
calibrating a control parameter for driving an electric motor of a brake mechanism mounted on a wheel based on a driving force acquired when the driving force on a driving wheel exceeds a braking force while the driving force is applied to the driving wheel with the braking force applied to the wheel by the brake mechanism, the brake mechanism being configured to transmit a thrust force generated by driving the electric motor to a piston, the piston being configured to move a braking member to be pressed against a braking receiving member.
